(19) United States
(12) Patent Application Publication
(10) Pub. No.: US 2014/0011410 A1
(43) Pub. Date: Jan. 9, 2014

(54) FIXING STRUCTURE OF SEPARATE LEAF SPRING

(71) Applicants: Tsuyoshi Hamai, Makinohara-shi (JP); Takuya Hasegawa, Fujieda-shi (JP)

(72) Inventors: Tsuyoshi Hamai, Makinohara-shi (JP); Takuya Hasegawa, Fujieda-shi (JP)

(73) Assignee: YAZAKI CORPORATION, Minato-ku, Tokyo (JP)

(21) Appl. No.: 14/005,470

(22) PCT Filed: Jun. 22, 2012
(86) PCT No.: PCT/JP2012/066625

§ 371 Date: Sep. 16, 2013

(30) Foreign Application Priority Data
Jun. 24, 2011 (JP) 2011-140765

(51) Int. Cl. H01R 13/187

(52) U.S. Cl. CPC H01R 13/187
USPC 439/847

(57) ABSTRACT

A fitting cylinder section 11 of a female terminal main body 10 includes a first side plate 11a from which a columnar body 15 for a rivet protrudes as one in a plurality of side wall plates forming a square cylinder shape, a leaf spring 20 fixed to the fitting cylinder section 11 has a rivet insertion hole 21a into which the columnar body 15 for the rivet can be inserted, and the fitting cylinder section 11 has a structure in which the leaf spring 20 is fixed to an inner section thereof by performing the press-molding in the square cylinder shape section after rivet-retaining the leaf spring 20 to the first side plate 11a in a deployment shape and before performing the press-molding in the square cylinder shape.

### TECHNICAL FIELD

The present invention relates to a fixing structure of a separate leaf spring which obtains a female terminal fitting of a structure in which a separate leaf spring is fixed into a fitting cylinder section of a female terminal main body formed by a press molding.

### BACKGROUND ART

FIGS. 7 and 8 show a fixing structure of a separate leaf spring in a female type terminal fitting shown in PTL 1 described below.

A female type terminal fitting 101 shown herein includes a female terminal main body 110 which is formed by press molding of a metallic plate, and a leaf spring 120 made of a metallic plate which is formed separately from the female terminal main body 110 and is fixed to the female terminal main body 110.

The female terminal main body 110 includes a square cylinder shaped fitting cylinder section 111 into which a male terminal can be inserted, and an electric wire pressing section 112 connected to a back side of the fitting cylinder section 111. The fitting cylinder section 111 and the electric wire pressing section 112 are formed by performing the press-molding. In the fitting cylinder section 111, fixing holes 130 for fixing the leaf spring 120 are formed through both side plates 111b which are bent and molded on both sides of a bottom plate 111a in a standing state.

The leaf spring 120 is fixed and installed in the fitting cylinder section 111. The leaf spring 120 presses the male type terminal inserted into the fitting cylinder section 111, and causes the male type terminal and the fitting cylinder section 111 to be in a conduction state.

As shown in FIG. 7, the leaf spring 120 is provided with fixing pieces 121 for joining to the fitting cylinder section 111 on both sides thereof.

In the fixing structure of the separate leaf spring disclosed in PTL 1 described below, as shown in FIG. 7, before molding the side plates 111b onto both sides of the bottom plate 111a in the standing state, the leaf spring 120 is mounted on the bottom plate 111a. In that state, by bending the side plates 111b of both sides of the bottom plate 111a in the standing state, and fitting the fixing pieces 121 of the both sides of the leaf spring 120 to the fixing hole 130 of the both side plates 111b, a state where the fixing hole 130 is fixed into the fitting cylinder section 111 is obtained.

### CITATION LIST

### Patent Literature

[PTL1] JP-A-2000-323217

### SUMMARY OF THE INVENTION

### Technical Problem

However, in the fixing structure of the separate leaf spring in PTL 1, when the leaf spring 120 causes a positional deviation during press molding, the fixing pieces 121 interfere with the edges of the fixing holes 130 and cause damage to the leaf spring 120 or the like.

For that reason, there is a need for a precise positioning technology for preventing positional deviation of the leaf spring during press molding. Thus, in the case of PTL 1, as shown in FIG. 8, a positioning piece 115 for precisely positioning the leaf spring 120 on the bottom plate 111a is cut out and formed. The positioning piece 115 abuts against the back surface of the leaf spring 120 mounted on the bottom plate 111a and restricts the displacement of the leaf spring 120.

However, in the fixing structure of the separate leaf spring of PTL 1, since the positioning piece 115 for preventing the positional deviation of the leaf spring 120 is cut and formed, there has been possibility in that it is difficult to secure sufficient strength in the fitting cylinder section 111.

Furthermore, even if the positioning piece 115 is equipped, when the leaf spring 120 is minutely displaced due to impact or the like acting at the time of the bending of the side plate 111b, there has been possibility in that an attachment defect of the leaf spring 120 may occur. For that reason, there is a need for a high precision press molding process of lower impact so that positional deviation of the leaf spring 120 is not generated, and thus there is possibility in that it is difficult to improve the molding properties.

The present invention has been made in view of situations that are described above. It is an object of the present invention to provide a fixing structure of a separate leaf spring in which it is easy to secure strength in a fitting cylinder section to which a leaf spring is fixed, and it is possible to improve the molding properties of the female terminal main body.

### Solution to Problem

In order to achieve the object, the present invention is achieved by a configuration described below.

(1) A fixing structure of a separate leaf spring in a female type terminal fitting, the fixing structure comprising:

a female terminal main body including a fitting cylinder section press-molded in a square cylinder shape and into which a male type terminal can be inserted; and

a leaf spring formed separately from the female terminal main body and fixed to the fitting cylinder section so that the male type terminal can be pressed by the leaf spring;

wherein the fitting cylinder section includes a first side plate from which a rivet columnar body protrudes, as one in a plurality of side wall plates forming the female main body into the square cylinder shape;

the leaf spring has a rivet retaining section that has a rivet insertion hole into which the rivet columnar body can be inserted, and that is fixed to the first side plate by a rivet-retaining that clamps a top section of the rivet columnar body inserted to the rivet insertion hole; and

the fitting cylinder section has a structure in which the leaf spring is fixed to an inner section of the fitting cylinder section by performing the press-molding in the square cylinder shape, after performing the rivet-retaining of the leaf spring in the first side plate in a deployment shape and before performing the press-molding in the square cylinder shape.

(2) The fixing structure of the separate leaf spring described in (1), wherein the leaf spring includes fixing pieces which protrude toward a second side plate of the fitting cylinder section that is bent and molded on both side edges of the first side plate in a standing state, and on both sides of the fixing plate connected to the rivet retaining section, and

the second side plate of the fitting cylinder section includes a spring fixing hole into which the fixing piece is fitted to fix the both sides of the fixing plate when being molded in both edges of the first side plate from a deployment form of the fitting cylinder section in a standing state.

According to the configuration of (1) mentioned above, when performing the press-molding of the fitting cylinder section of the female terminal main body in a square cylinder shape, the separate leaf spring is fixed to the first side plate by the rivet-retaining in advance. Thus, when performing the press-molding of the fitting cylinder section of the female terminal main body, it is not necessary to cut and form a high precision positioning piece for preventing the positional deviation of the leaf spring in the fitting cylinder section. Furthermore, the position of the leaf spring does not deviate due to impact when performing the press-molding of the fitting cylinder section.

Thus, it is easy to secure strength in the fitting cylinder section to which the leaf spring is fixed. Furthermore, since there is no need for high precision press-molding of less impact, the molding properties of the female terminal main body can be improved.

According to the configuration of (2) mentioned above, since the fixing of the separate leaf spring to the fitting cylinder section is a double fixing structure of the rivet-retaining to the first side plate and a fitting structure in which the fixing piece equipped in the leaf spring is fitted to the spring fitting hole of the second side plate, reliability of the fixing to the separate spring can be improved.

### Advantageous Effects of Invention

According to the fixing structure of the separate leaf spring of the present invention, when performing the press-molding of the fitting cylinder section of the female terminal main body in a square cylinder shape, the separate leaf spring is fixed to the first side plate by the rivet-retaining in advance. Thus, there is no need to cut and form the high precision positioning piece for preventing the positional deviation of the leaf spring when performing the press-molding of the fitting cylinder section of the female terminal main body, in the fitting cylinder section. Furthermore, the position of the leaf spring does not deviate due to the impact or the like when performing the press-molding of the fitting cylinder section.

Thus, it is easy to secure the strength in the fitting cylinder section to which the leaf spring is fixed. Furthermore, since there is no need for the high-precision press-molding of less impact, the molding properties of the female terminal main body can be improved.

### BRIEF DESCRIPTION OF THE DRAWINGS

FIG. 1 is a perspective view of an embodiment of a female type terminal fitting to which a leaf spring is fixed by a fixing structure of a separate leaf spring according to the present invention.

FIG. 2 is a longitudinal cross-sectional view of the female type terminal fitting shown in FIG. 1.

FIG. 3 is a perspective view of a deployment shape of a terminal base material formed in the female terminal main body shown in FIG. 1 and the separate leaf spring fixed to the female terminal main body.

FIG. 4 is a perspective view of a first punching plate material continuously formed with a plurality of terminal base materials shown in FIG. 3 and a second punching plate material continuously formed with a plurality of leaf springs.

FIG. 5 is a perspective view of a state where the leaf spring on the second punching plate material shown in FIG. 4 is rivet-retained in the terminal base material on the first punching plate material.

FIG. 6 is a perspective view of a state where the leaf spring rivet-retained in the terminal base material on the first punching plate material is separated from the second punching plate material.

FIG. 7 is a perspective view that shows a fixing structure of a separate leaf spring in a female type terminal fitting of the related art.

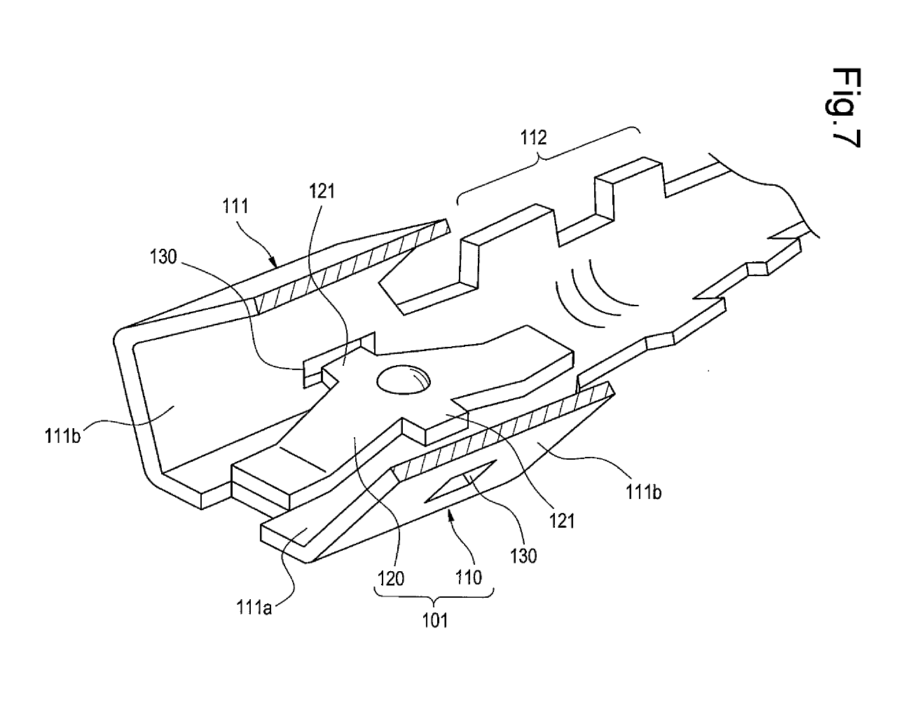

FIG. 8 is a longitudinal cross-sectional view of a press-molding completion state of the female type terminal fitting shown in FIG. 7.

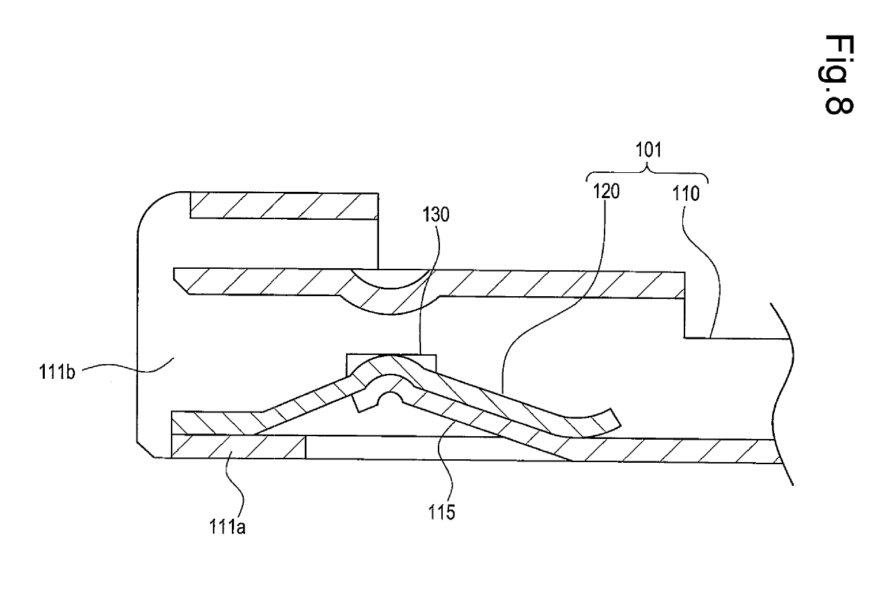

### DESCRIPTION OF EMBODIMENTS

Hereinafter, a preferred embodiment of a fixing structure of a separate leaf spring according to the present invention will be described in detail with reference to the drawings.

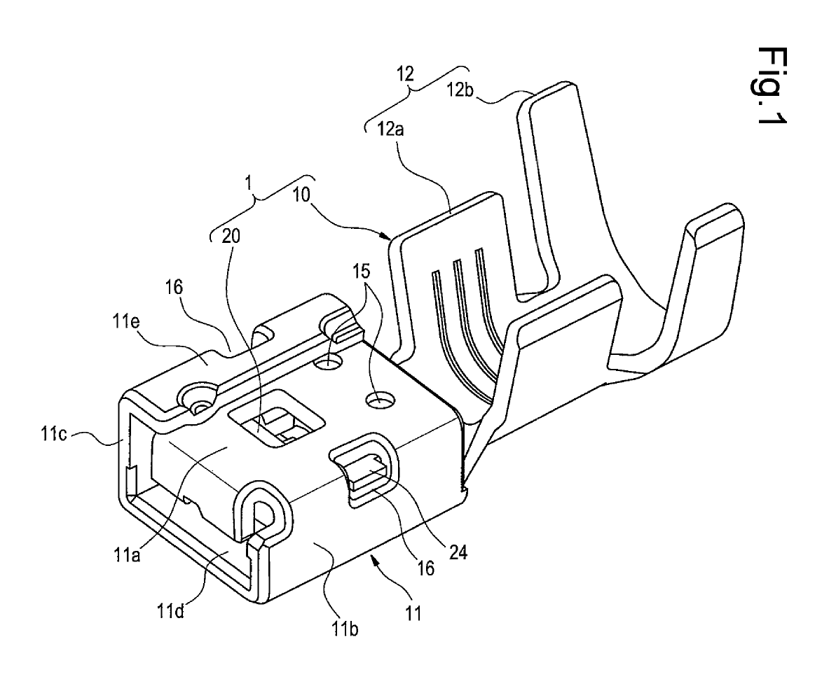

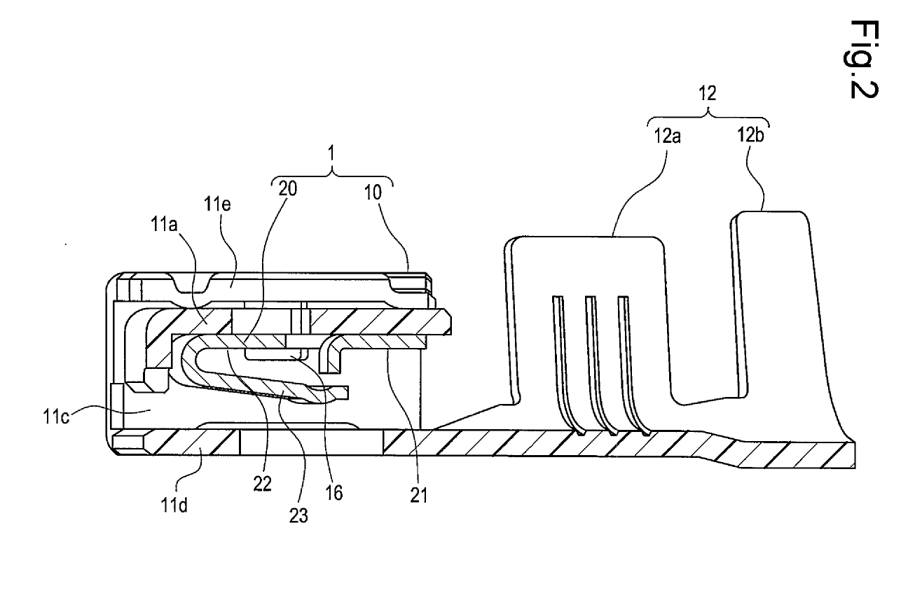

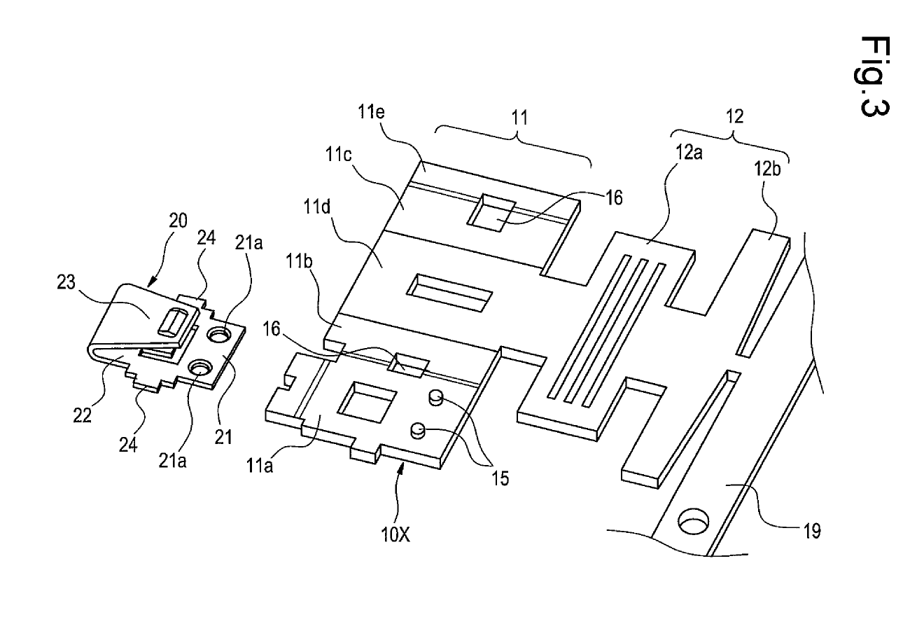

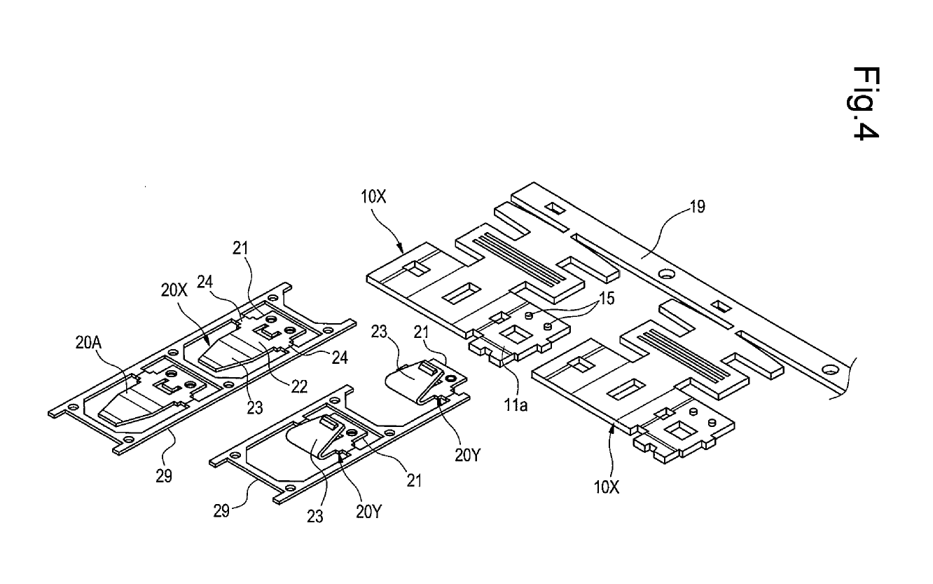

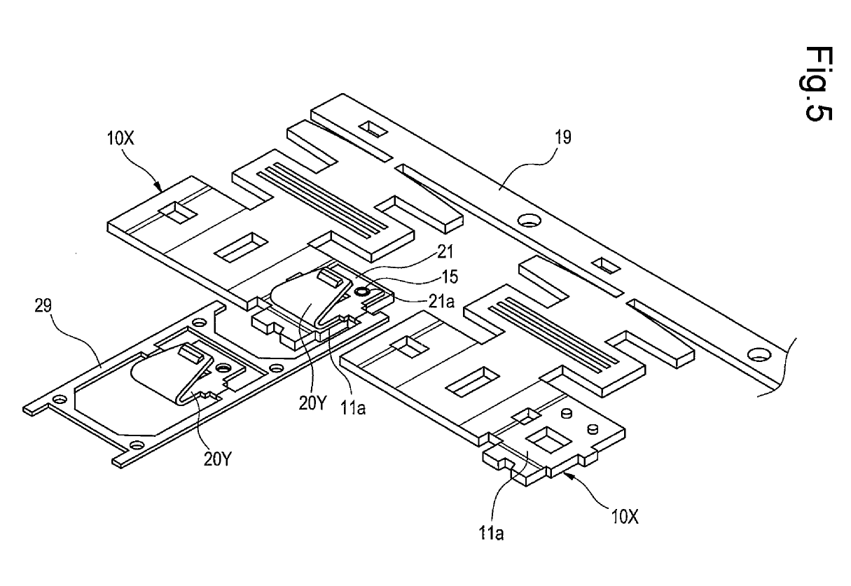

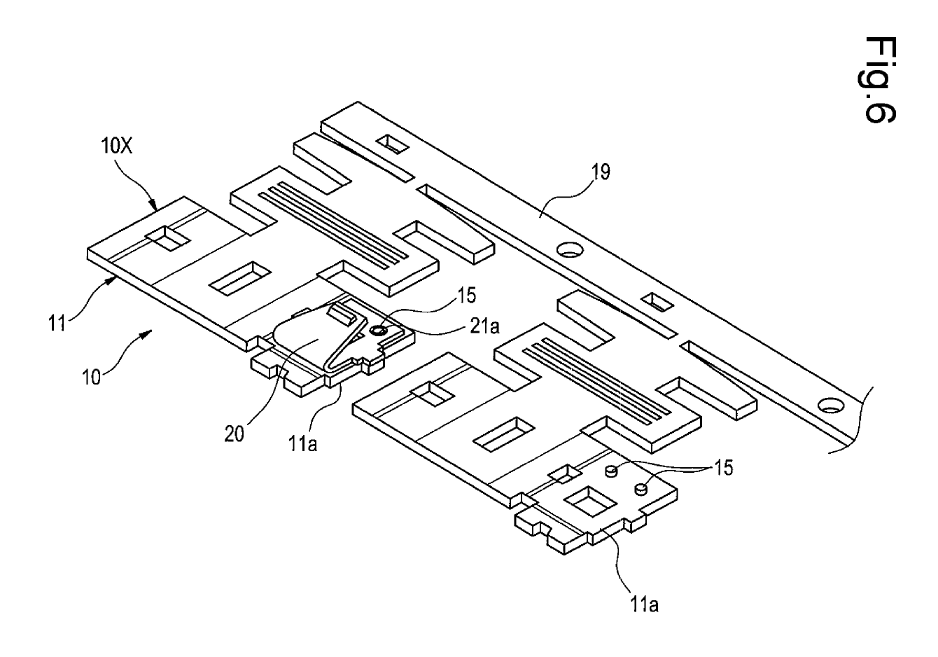

FIGS. 1 to 6 show an embodiment of a fixing structure of a separate leaf spring according to the present invention. FIG. 1 is a perspective view of an embodiment of a female type terminal fitting to which a leaf spring is fixed by a fixing structure of a separate leaf spring according to the present invention. FIG. 2 is a longitudinal cross-sectional view of the female type terminal fitting shown in FIG. 1. FIG. 3 is a perspective view of a deployment shape of a terminal base material formed in the female terminal main body shown in FIG. 1 and the separate leaf spring fixed to the female terminal main body. FIG. 4 is a perspective view of a first punching plate material continuously formed with a plurality of terminal base materials shown in FIG. 3 and a second punching plate material continuously formed with a plurality of leaf springs. FIG. 5 is a perspective view of a state where the leaf spring on the second punching plate material shown in FIG. 4 is rivet-retained in the terminal base material on the first punching plate material. FIG. 6 is a perspective view of a state where the leaf spring rivet-retained in the terminal base material on the first punching plate material is separated from the second punching plate material.

A female terminal fitting 1 shown in FIGS. 1 and 2 includes a female terminal main body 10 formed by the press-molding of a metallic plate, and a leaf spring 20 made of a metallic plate which is formed separately from the female terminal main body 10 and is fixed to the female terminal main body 10.

The female terminal main body 10 includes a fitting cylinder section 11 of a square cylinder shape to which a male type terminal can be inserted, and an electric wire pressing section 12 connected to the back side of the fitting cylinder section 11. The fitting cylinder section 11 and the electric wire pressing section 12 are formed by the press-molding.

The fitting cylinder section 11 forms a rectangular cylinder structure formed of five plates which include a first side plate 11a covering an upper section in FIG. 2, a pair of second side plates 11b and 11c bent and molded on both sides of the first side plate 11a in a vertically standing state, a third side plate 11d covering the lower section facing the first side plate 11a, and a fourth side plate 11e formed on one end of the first side plate 11a in an overlapping form.

The electric wire pressing section 12 includes a conductor clamping piece 12a which compresses a conductor of the electric wire, and an electric wire clamping piece 12b which fixes a covered section of the electric wire.

FIG. 3 shows a terminal base material 10X which is a material prior to formation into the female terminal main body 10. The terminal base material 10X is formed by punching a metallic plate in a deployment shape of the female terminal main body 10. As shown in FIG. 4, the terminal base material 10X is firstly punched in a state where a plurality of terminal base materials 10X are connected to each other by a connection frame 19. In addition, in the deployment state shown in the terminal base material 10X, by denoting the same reference numerals as those of each part after the molding, the placement of each part is shown.

As shown in FIGS. 1 and 3, in the case of the female terminal main body 10, as means for fixing the leaf spring 20, a columnar body 15 for a rivet, and a spring fixing hole 16 are included.

As shown in FIG. 3, a plurality of (herein, two) columnar bodies 15 for the rivet protrude from an inner surface of the first side plate 11a which is one of a plurality of side plates constituting the fitting cylinder section 11.

The spring fixing hole 16 is a hole for fixing the leaf spring 20, and as shown in FIGS. 1 and 3, is formed through a pair of second side plates 11b and 11c facing each other.

As shown in FIGS. 2 and 3, the leaf spring 20 includes a rivet retaining section 21, a fixing plate 22 connected to one end of the rivet retaining section 21, a spring main body 23 which is folded from the tip of the fixing plate 22 to the rivet retaining section 21 side, and a pair of fixing pieces 24 which is extended and formed on both sides of the fixing plate 22.

A rivet insertion hole 21a, into which the columnar body 15 for the rivet is inserted, is formed through the rivet retaining section 21 corresponding to the arrangement of the columnar body 15 for the rivet in the first side plate 11a. The rivet retaining section 21 is fixed to the first side plate 11a by the rivet-retaining clamping the top section of the columnar body 15 for the rivet inserted to the rivet insertion hole 21a.

The fixing plate 22 is a plate-like section which comes into surface-contact with the first side plate 11a together with the rivet retaining section 21, and is extended to one side of the rivet retaining section 21.

The spring main body 23 is a tongue-like piece extended and formed to the tip of the fixing plate 22, and is a part which comes into pressure-contact with the male type terminal inserted to the fitting cylinder section 11.

The fixing pieces 24 are parts which are fixed to the fitting cylinder section 11 by being fitted to the spring fixing holes 16 formed in the second side plates 11b and 11c. The fixing pieces 24 are provided on both sides of the fixing plate 22.

As shown in FIGS. 1 and 2, the leaf spring 20 of the present embodiment is fixed to an inner section of the fitting cylinder section 11 by the rivet-retaining using the columnar body 15 for the rivet inserted to the rivet insertion hole 21a and the positional restriction of the fitting of the fixing piece 24 to the spring fixing hole 16. The plate spring 20 fixed into the fitting cylinder section 11 presses the male type terminal inserted to the fitting cylinder section 11 by the spring main body 23, and makes the male type terminal and the fitting cylinder section 11 the conduction connection state.

FIG. 4 shows a spring base material 20X which is a material prior to molding into the leaf spring 20, and a secondary spring base material 20Y formed by bending a part of the spring base material 20X.

The spring base material 20X is made by punching a metallic plate to a deployed shape of the leaf spring 20. The spring base material 20Y is made by molding the spring main body 23 in the spring base material 20 into a final bending shape. In the state of the spring base material 20X and the secondary spring base material 20Y, a plurality of base materials are handled by a shape in which a plurality of base materials are connected by the connection frame 29. In addition, in the deployed shape shown in the spring base material 20X, by denoting the same reference numeral as those of each part after the molding, the displacement of each part is shown.

In the case of the female type terminal fitting of an embodiment, the fixing of the leaf spring 20 to the fitting cylinder section 11 is performed by the sequence below.

Firstly, as shown in FIG. 5, by fitting the columnar body 15 for the rivet on the terminal base material 10X to the rivet insertion hole 21a of the secondary spring base material 20Y in which the bending of the spring main body 23 is completed, the secondary spring base material 20Y is positioned in the first side plate 11a of the terminal base material 10X.

Next, the top section of the columnar body 15 for the rivet is clamped to perform the fixing using the rivet-retaining, and the secondary base material 20Y is separated from the connection frame 29. Thus, as shown in FIG. 6, a form is obtained in which the leaf spring 20 is rivet-retained to the first side plate 11a of the terminal base material 10X.

Next, by applying a predetermined press processing to the terminal base material 10X to which the leaf spring 20 is rivet-retained, the female type terminal fitting 1 shown in FIGS. 1 and 2 is obtained.

That is, in the fixing structure of the separate leaf spring in the present embodiment, the fitting cylinder section 11 obtains a structure in which the leaf spring 20 is fixed into the inner section of the fitting cylinder section 11 by performing the press-molding in the square cylinder shape after rivet-retaining the leaf spring 20 to the first side plate 11a in the deployed shape and before performing the press-molding in the square cylinder shape.

Furthermore, in the process of performing the press-molding of the terminal base material 10X, to which the leaf spring 20 is rivet-retained, in the square cylinder shape, when the second side plates 11b and 11c of the fitting cylinder section 11 are bent and molded in a state of standing from the deployed state shown in the terminal base material 10X to the both side edges of the first side plate 11a, the fixing piece 24 is fitted to the spring fixing hole 16, whereby a state is obtained where the both sides of the fixing plate 22 of the leaf spring 20 are fixed.

According to the fixing structure of the separate leaf spring in an embodiment mentioned above, when performing the press-molding of the fitting cylinder section 11 of the female terminal main body 10 in the square cylinder shape, the separate leaf spring 20 is fixed to the first side plate 11a by the rivet-retaining in advance. Thus, when performing the press-molding of the fitting cylinder section 11 of the female terminal main body 10, there is no need to cut and form a high precision positioning piece for preventing the positional deviation of the leaf spring 20 in the fitting cylinder section 11. Furthermore, the position of the leaf spring 20 does not deviate due to the impact or the like when performing the press-molding the fitting cylinder section 11.

Thus, it is easy to secure the strength in the fitting cylinder section 11 to which the leaf spring 20 is fixed. Furthermore, since there is no need for the high precision press-molding of less impact, the molding properties of the female terminal main body 10 can be improved.

Furthermore, according to the fixing structure of the separate leaf spring in an embodiment, since the fixing of the separate leaf spring 20 to the fitting cylinder section 11 has a double fixing structure achieved by rivet retaining to the first side plate 11a and the fitting structure in which the fixing piece 24 equipped in the leaf spring 20 is fitted to the spring fixing hole 16 of the second side plates 11b and 11c, it is possible to improve the reliability of the fixing to the separate leaf spring 20.

In addition, the fixing structure of the separate leaf spring of the present invention is not limited to the various embodiments mentioned above, but suitable modifications, improvements or the like are possible.

For example, in the respective embodiments mentioned above, as the fixing means of the separate leaf spring to the fitting cylinder section, the double fixing structure has been adopted by also including the fitting structure in which the fixing piece equipped in the leaf spring is fitted into the spring fixing hole of the fitting cylinder section. However, in a case where it is possible to secure sufficient fixing strength with only the rivet retaining section, the fitting structure of the fixing piece and the spring fixing hole may be omitted.

This application is based upon and claims the benefit of priority of Japanese Patent Application No. 2011-140765 filed on Jun. 24, 2011, the contents of which are incorporated herein by reference.

### INDUSTRIAL APPLICABILITY

According to the fixing structure of the separate leaf spring of the present invention, when performing the press-molding of the fitting cylinder section of the female terminal main body in a square cylinder shape, the separate leaf spring is fixed to the first side plate by the rivet-retaining in advance. Thus, there is no need to cut and form the high precision positioning piece for preventing the positional deviation of the leaf spring when performing the press-molding of the fitting cylinder section of the female terminal main body, in the fitting cylinder section. Furthermore, the position of the leaf spring does not deviate due to the impact or the like when performing the press-molding of the fitting cylinder section.

### REFERENCE SIGN LIST

1: female type terminal fitting
10: female terminal main body
11: fitting cylinder section
11a: first side plate
11b, 11c: second side plate
15: columnar body for rivet
16: spring fixing hole
20: leaf spring
21: rivet retaining section
21a: rivet insertion hole
24: fixing piece

1. A fixing structure of a separate leaf spring in a female type terminal fitting, the fixing structure comprising:
a female terminal main body including a fitting cylinder section press-molded in a square cylinder shape and into which a male type terminal can be inserted; and
a leaf spring formed separately from the female terminal main body and fixed to the fitting cylinder section so that the male type terminal can be pressed by the leaf spring;
wherein the fitting cylinder section includes a first side plate from which a rivet columnar body protrudes, as one in a plurality of side wall plates forming the female main body into the square cylinder shape;
the leaf spring has a rivet retaining section that has a rivet insertion hole into which the rivet columnar body can be inserted, and that is fixed to the first side plate by a rivet-retaining that clamps a top section of the rivet columnar body inserted to the rivet insertion hole; and
the fitting cylinder section has a structure in which the leaf spring is fixed to an inner section of the fitting cylinder section by performing the press-molding in the square cylinder shape, after performing the rivet-retaining of the leaf spring in the first side plate in a deployment shape and before performing the press-molding in the square cylinder shape.

2. The fixing structure of the separate leaf spring according to claim 1, wherein the leaf spring includes fixing pieces which protrude toward a second side plate of the fitting cylinder section that is bent and molded at both side edges of the first side plate in a standing state, and on both sides of the fixing plate connected to the rivet retaining section, and
the second side plate of the fitting cylinder section includes a spring fixing hole into which the fixing piece is fitted to fix the both sides of the fixing plate when being molded in both edges of the first side plate from a deployment shape of the fitting cylinder section in a standing state.
